(19) United States
(12) Patent Application Publication
(10) Pub. No.: US 2018/0047042 A1
(43) Pub. Date: Feb. 15, 2018

(54) SYSTEM AND METHOD FOR LUCKY DRAW

(71) Applicant: SOSUN CORPORATION, Tokyo (JP)

(72) Inventor: ICHU FUKUZAWA, TOKYO (JP)

(21) Appl. No.: 15/559,833

(22) PCT Filed: Apr. 13, 2016
(86) PCT No.: PCT/JP2016/062577

§ 371 Date: Sep. 20, 2017

(30) Foreign Application Priority Data
Apr. 17, 2015 (JP) 2015-096046
Apr. 24, 2015 (JP) 2015-100473

(51) Int. Cl. G06Q 30/02; G07F 17/32; G07B 1/06

(52) U.S. Cl. CPC G06Q 30/0209; G07B 1/06; G07F 17/329; G07F 17/3225; G07F 17/3241; G07F 17/326

(57) ABSTRACT

The invention provides a lucky draw system, so that consumers always able be unrestricted by the conditions, as long as the purchase of goods or services according to their own needs can get the lucky draw chance free, can get bonuses free after winning. The lucky draw system comprising: a server for providing a points and a lucky draw number on the basis of a customer information; a terminal for log in and providing the customer information, and providing a points and a lucky draw number to a lucky draw card or a lucky draw ticket; the lucky draw card for accumulating automatically and recording the points and the lucky draw number; for participating the lucky draw, and for redeeming bonus after winning the lucky draw; the lucky draw ticket for using when the time when the customer did not prompt. An implementation method thereof is also provided.

### BACKGROUND

### Field

The invention relates to the technical field of computer application software, in particular to a lucky draw system and an implementation method thereof.

### Background

In business activities, the seller often by hosting a sweepstakes for attract consumers and sales promotion, in order to avoid the risk, the seller will set some restrictions like the purchase time, the purchase place, the purchase goods, the purchase amount, membership and so on, only to meet these restrictions can to participate in sweepstakes, this objectively let the customers to take the a part of the risk, it can infect customers with a sense of urgency, if you don't catch up, you'll miss the chance, some customers are impulse to spend in order to get the lucky draw, after that regret buying goods or services that should not be bought, produce unnecessary disputes, it is also prone to problems such as improper use of personal information. How can let the enterprises promote the sales, meanwhile also let the customer do not need to take risks, as long as the purchase of goods or services will be able to draw the fun of winning and winning the prize after the surprise, this is the topic that this invention wants to solve.

The invention provides a lucky draw system, so that consumers always able be unrestricted by the conditions, as long as the purchase of goods or services according to their own needs can get of the lucky draw chance free of charge, can get bonuses free of charge after winning. The lucky draw system comprising: a server for providing a points and a lucky draw number on the basis of a customer information; a terminal for log in and providing the customer information, and providing a points and a lucky draw number to a lucky draw card or a lucky draw ticket; the lucky draw card for accumulating automatically and recording the points and the lucky draw number; for participating the lucky draw, and for redeeming bonus after winning the lucky draw; the lucky draw ticket for using when the time when the customer did not prompt. An implementation method thereof is also provided.

### SUMMARY

The invention provides a lucky draw system, so that consumers can be unrestricted, as long as the purchase of goods or services according to their own needs can get the lucky draw chance free, can get bonuses free after winning.

The lucky draw system comprising: a server: a terminal connecting to the server via the network; and a lucky draw card able be read and written by the terminal; and a lucky draw ticket using to instead of the lucky draw card.

The server comprising: a communication unit comprising: communicating with the terminal to receiving a customer information; and to sending the information data of updating the record of the lucky draw card or printing the record of a lucky draw ticket; a verification unit comprising: verifying effectiveness of the customer information based on the information data from stored in the server, to determine the continuation or termination of the ongoing procedure, if the customer information is valid, continue, and if is invalid, abort; a process unit comprising: processing the customer information through the established procedures; converting the customer information to a points according to an established conversion standards, converting the points to a lucky draw number according to an established conversion standards, wherein the lucky draw number no repetition and no conflict; and generating the new information data for updating the record of the lucky draw card or printing the record of the lucky draw ticket, the generated information data include the part of the points exceeded the conversion standard; a memory unit comprising saving the related information of communication between the server and the terminal; and a database comprising storing and managing the basic data needed by the server when processing and generating information data.

The terminal comprising: a customer unit comprising: entering the customer information, the customer information including such as the information that can get the points free of charge by purchases of goods or services or by participate in the questionnaire survey, and including the information of the lucky draw card, but do not including personal information; a terminal communication unit comprising: connecting with the server via the network for exchanging information with the server to transmitting the customer information and receiving the data for updating the record of the lucky draw card or printing the lucky draw ticket; and a record unit comprising: updating the record of the lucky draw card or printing the lucky draw ticket, wherein updating the lucky draw card record including updating the information stored in the lucky draw card and updating the record that print on the lucky draw card surface.

The lucky draw card comprising: do not involving personal information; able to store information and be read and written by the terminal; using for automatically accumulate the points and the lucky draw number; using for recording the obtained the points and the obtained lucky draw number, using for participate the lucky draw and for the bonus exchange after winning; on the surface of the lucky draw card there is: the points; the lucky draw number; the lucky draw card name; the card number; the transform value; the capacity; the lucky draw date; the validity period of the bonus exchange; and other information; wherein the printed lucky draw number record can only be increase and cannot be change, and when the amount of the points reaches or exceeds the conversion standard, printing the changed the points and the changed lucky draw number.

The lucky draw ticket comprising: do not involving personal information; printing out via the terminal; on the surface of the lucky draw ticket there is: the lucky draw number; the lucky draw ticket name; the lucky draw date; the validity period of the bonus exchange; the terminal number; the server number; and other information; using for participate the lucky draw and for the bonus exchange after winning.

Wherein the points using for exchange the lucky draw number, is given by a franchisee through the terminal when the customer purchases goods or services, any customer who buys goods or services at the franchisee can get the points; the points is issued by the server and is recorded on the belonging to the customer lucky draw card through the terminal, or is printed deliver to the customer; the lucky draw number is issued by the server, is recorded on the belonging to the customer lucky draw card through the terminal, and or is printed on the lucky draw ticket by the terminal deliver to the customer.

The invention provides also an implementation method thereof the lucky draw system, the implementation method comprising the steps of: the system operator set up the server, set the rules of the system running method, install the relevant software, store the information needed for the operation of the system; the system operator set up the terminals on the franchisee, issuing the lucky draw card and distribute them to the consumer; the customer buy goods or services from the franchisee, and the franchisee enter the customer information in the terminal; the terminal sending the customer information to the server via the network; the server recognizes the validity of the customer information: if invalid, abort; if valid, move to the next step; the server processes the customer information, calculates the corresponding number of the points and the number of the lucky draw number, generates the new data and updates the memory; the server returns the generated new data to the terminal and save the correspondence record; according to the data of the returned, the terminal updating the lucky draw card record (in case the customer has the lucky draw card), or printing the lucky draw ticket (in case the customer does not have the lucky draw card); the customer using the lucky draw card or the lucky draw ticket to participate lucky draw, the card has the lucky draw number; and the customer using the lucky draw card or the lucky draw ticket wherein containing the winning number to redeem bonus, the bonus pay by the system operator.

### BRIEF DESCRIPTION OF THE DRAWINGS

For a more complete understanding of the present disclosure, reference is now made to the following description taken in conjunction with the accompanying drawings.

FIG. 1 is a schematic view of the basic structure of the lucky draw system 10 provided by the embodiment of the invention.

FIG. 2 is a schematic view of the overall structure of the lucky draw system 10 provided by the embodiment of the invention.

FIG. 3 is a schematic view of relevant the lucky draw system 10 provided by the embodiment of the invention.

FIG. 4 is a schematic block diagram of the server 100 and the terminal 200 provided by the embodiment of the invention.

FIG. 5 is a schematic view of the lucky draw card 300 provided by the embodiment of the invention.

FIG. 6 is a schematic view of the lucky draw ticket 400 provided by the embodiment of the invention.

FIG. 7 is a flow chart of the lucky draw system implementation method provided by an embodiment of the present invention.

### DETAILED DESCRIPTION

The embodiment of the invention provides the lucky draw system 10 and its realization method, in the hope of through provide utilize the lucky draw system 10 and implementing method thereof composed of computer application software technology to achieve the purpose. In order for the personnel in the technical field to better understand the present invention, the following will referring to the drawings for describe in detail some embodiments of the present invention through showing the example rather than a restrictive manner. Since the embodiments described are only part of the embodiment of the present invention, therefore, other embodiments based on the present invention are included, should all belong to the scope of protection of the invention.

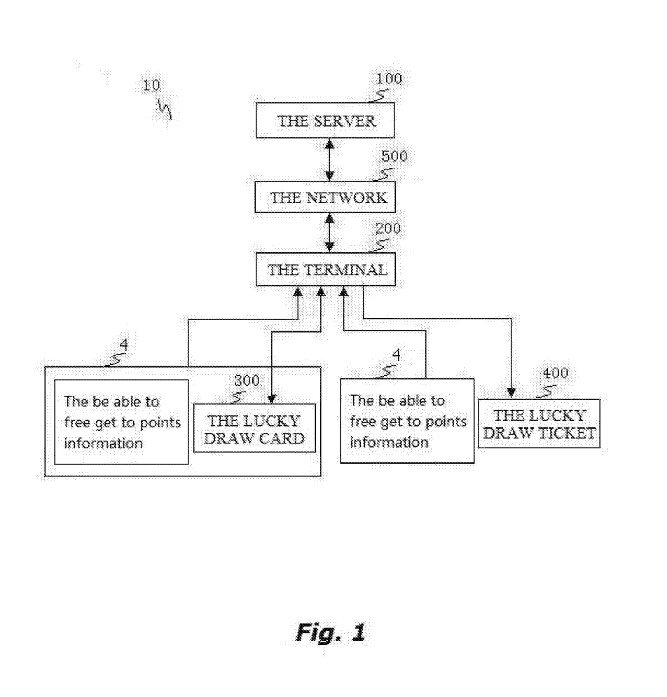

FIG. 1 is a schematic view of the basic structure of the lucky draw system 10 provided by the embodiment of the invention, FIG. 1 shows the upward arrow lines say the customer information 4 is sent to the server 100 through the network 500 after at the terminal 200 is logged in, processing the customer information 4 through the established procedures, converting the customer information 4 to the points according to an established conversion standards, converting the points to the lucky draw number according to an established conversion standards, generating the new information data for updating the record of the lucky draw card 300 or printing the record of the lucky draw ticket 400. The customer information 4 includes the information that the customer 3 bring the franchisee 2 the benefits by purchasing goods or services, also including the information of the lucky draw card 300, but does not include the customer 3's personal information, the customer information 4 used to get the points.

Can see from FIG. 1. there are two types of the customer information 4, one is the customer information 4 containing the lucky draw card 300 information, and the other is the customer information 4 that does not contain the lucky draw card 300 information, the terminal 200 update the lucky draw card 300 record based on the returned information when the customer information 4 containing the lucky draw card 300 information, and the terminal 200 print the lucky draw ticket 400 based on the returned information when the customer information 4 containing the lucky draw card 300 information.

The lucky draw system 10 does not involve the customer 3's personal information; one of the server 100 corresponds to multiple of the terminal 200, one of the terminal 200 corresponds to multiple of the lucky draw card 300; the lucky draw number on the lucky draw card 300 and the lucky draw ticket 400 has the same function and effect.

The downward arrow lines say the server 100 returns the information to the terminal 200 through the network 500, in the returned information there is the information of the points and the lucky draw number, based on the returned information the terminal 200 update the lucky draw card 300 record or print the lucky draw ticket 400.

Wherein the points using for exchange the lucky draw number, is given by a franchisee through the terminal 200 when the customer 3 purchases goods or services, any the customer 3 who buys goods or services at the franchisee 2 can get the points; the points is issued by the server 100 and is recorded on the belonging to the customer 3 the lucky draw card 300 through the terminal 200, or is printed then deliver to the customer 3.

Wherein the lucky draw number is issued by the server 100, is recorded on the belonging to the customer 3 the lucky draw card 300 through the terminal 200, and or is printed on the lucky draw ticket 400 by the terminal 200 then deliver to the customer 3;

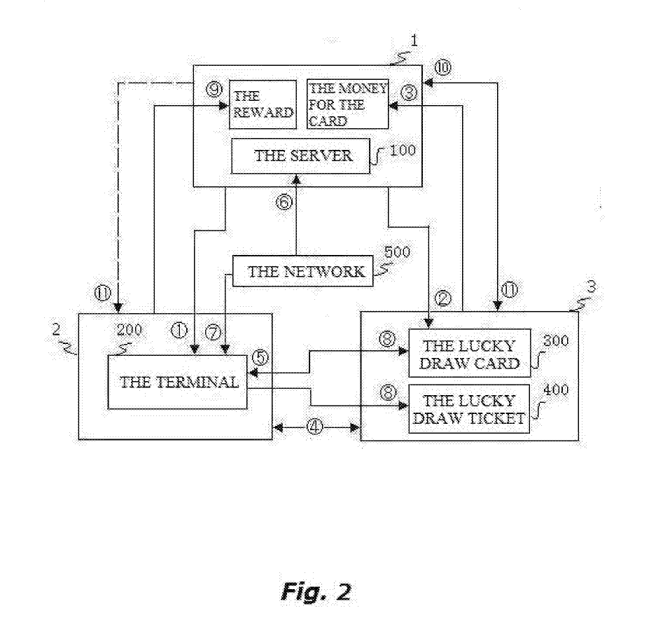

FIG. 2 is a schematic view of the overall structure of the lucky draw system 10 provided by the embodiment of the invention. In FIG. 2: the arrow line \textcircled{1} say the system operator 1 set the terminal 200 at the franchisee 2, the franchisee 2 refers to the seller that can use the terminal 200, any seller can become the franchisee 2s; the arrow line \textcircled{2} say The system operator 1 issue the lucky draw card 300 to the customer 3; the arrow line \textcircled{3} say The customer 3 purchase the lucky draw card 300; the arrow line \textcircled{4} say the customer 3 buy goods or services at the franchisee 2; the arrow line \textcircled{5} say the situation that the customer 3 prompting the lucky draw; the arrow line \textcircled{6} say the terminal 200 send the customer information 4 to the server 100 through the network 500; the arrow line \textcircled{7} say the server 100 returns the information to the terminal 200 through the network 500; the arrow line \textcircled{8} say the terminal 200 update the lucky draw card 300 record or prints the lucky draw ticket 400 based on the returned information; the arrow line \textcircled{9} say the franchisee 2 pay rewards to the system operator 1; the arrow line \textcircled{10} say the customer 3 hold the lucky draw card 300 or the lucky draw ticket 400 to participate lucky draw of the operator: the arrow line \textcircled{11} say the system operator 1 offer bonus to the winners; the arrow dotted line \textcircled{11} say the system operator 1 can also provide rewards to the franchisee 2 associated with winning numbers.

Wherein the lucky draw ticket 400 comprising: using for recording the obtained the lucky draw number when the customer 3 without prompting the lucky draw card 300; used in the lucky draw; using for participate lucky draw activities provide by the system operator 1; using for redeem bonus; can meanwhile record the lucky draw number and the excess the points on the lucky draw ticket 400, but the lucky draw number and the points cannot be accumulated automatically on the lucky draw ticket 400.

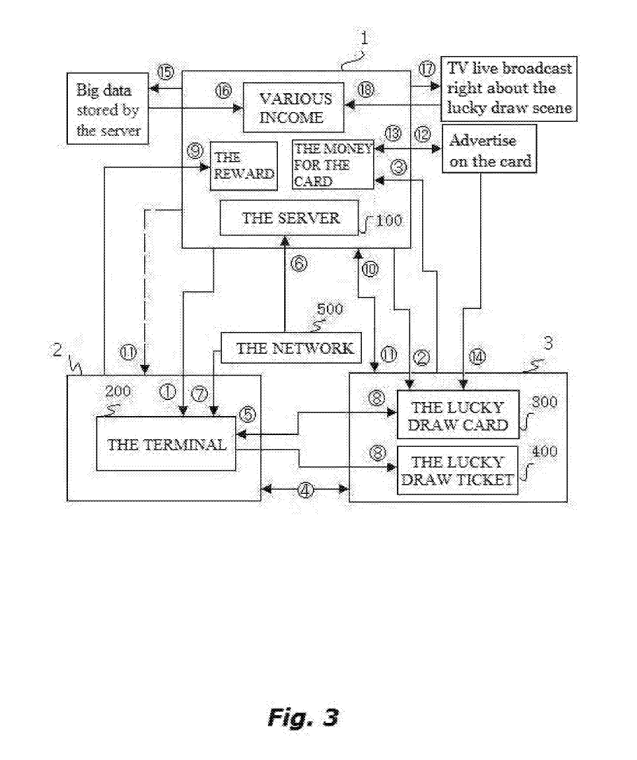

FIG. 3 is a schematic view of relevant the lucky draw system 10 provided by the embodiment of the invention. The part from the arrow line 1 to the arrow line 12 in the FIG. 3 is identical, do not repetitive specification here. In FIG. 3, the arrow line \textcircled{12} say the system operator 1 provide the right of advertise on the lucky draw; the arrow line \textcircled{13} say the system operator 1 harvest advertising fees; the arrow line \textcircled{14} say the right holder of put an advertisement on the lucky draw card 300 provide the lucky draw card 300 to the customer 3; the arrow line \textcircled{15} say the system operator 1 provides big data stored by the server, the arrow line \textcircled{16} say the system operator 1 get the paid by provide the big data: the arrow line \textcircled{17} say the system operator 1 provide TV live broadcast right about the lucky draw scene; the arrow line \textcircled{18} say the system operator 1 receive remuneration for provide the rights to provide live broadcast of television stations.

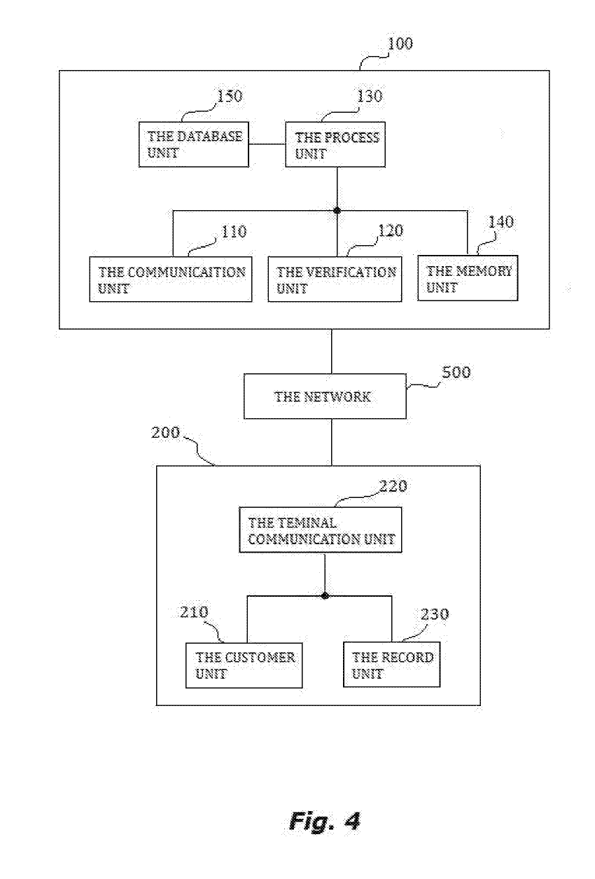

FIG. 4 is a schematic block diagram of the server 100 and the terminal 200 provided by the embodiment of the invention. FIG. 4 shows the server 100 is connected with the terminal 200 through the network 500. the server 100 comprising: the communication unit 110 communicating with the terminal 200 to receiving the customer information 4 and to sending the information data of updating the record of the lucky draw card 300 or printing the record of the lucky draw ticket 400; the verification unit 120 verifying effectiveness of the customer information 4 based on the information data from stored in the server 100, to determine the continuation or termination of the ongoing procedure, if the customer information 4 is valid, continue, and if is invalid, abort, the process unit 130 processing the customer information 4 through the established procedures, converting the customer information 4 to the points according to an established conversion standards, converting the points to the lucky draw number according to an established conversion standards, generating the new information data for updating the record of the lucky draw card 300 or printing the record of the lucky draw ticket 400, the generated information data Include the part of the points exceeded the conversion standard; the memory unit 140 comprising saving the related information of communication between the server 100 and the terminal 200; and the database 150 comprising storing and managing the basic data needed by the server 100 when processing and generating information data.

FIG. 4 shows the terminal 200 comprising; the customer 3 unit log in the customer information 4 that including the information that can get the points free of charge by purchases of goods or services or by participate in the questionnaire survey, and the information of the lucky draw card 300, but do not including personal information; the terminal communication unit 220 connecting with the server 100 through the network 500 for exchanging information with the server 100 to transmitting the customer information 4 and receiving the for updating the record of the lucky draw card 300 or printing the lucky draw ticket 400; and the record unit 230 updating the record of the lucky draw card 300 or printing the lucky draw ticket 400, wherein updating the lucky draw card 300 record including updating the information stored in the lucky draw card 300 and updating the record that print on the lucky draw card 300 surface.

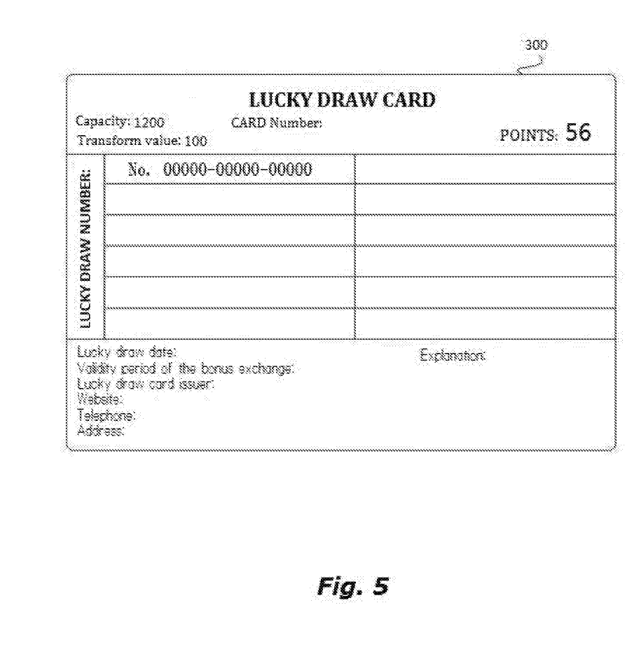

FIG. 5 is a schematic view of the lucky draw card 300 provided by the embodiment of the invention. The lucky draw card 300 includes: can read and enter the information by the terminal 200 and can print the information to the surface by the terminal 200; do not involve personal information; using for automatically accumulate the points and the lucky draw number; using for recording the obtained the points and the obtained the lucky draw number, using for the lucky draw; used to redeem bonus after winning the lucky draw. Can see from FIG. 5, on the surface of the lucky draw card 300 there is “LUCKY DRAW CARD”, “POINTS”, “LUCKY DRAW NUMBER”, “Card number”, “Transform value”, “Capacity”, “Lucky draw date”, “Validity period of the bonus exchange” and other information. Of which: “LUCKY DRAW CARD” say the name of the lucky draw card 300; “POINTS” say the number of the points accumulated in the lucky draw card 300, and “POINTS” varies with the accumulation of the points; “LUCKY DRAW NUMBER” say the number of the lucky draw number accumulated in the lucky draw card 300, the lucky draw number record can only be added and cannot be changed; “Transform value” say a transform standard that the points transform into the lucky draw number, when the quantity of the points reaches the transform standard, the quantity of the points transform into the lucky draw number, when the quantity of the points exceeds the transform standard, the quantity of the points transform into the lucky draw number and the exceeds standard part of the points; “Capacity” say the lucky draw card 300 can record the maximum number of the points on the lucky draw card 300, in order to convenient carry, the lucky draw card 300 volume is relatively small, the surface can be printed on the place is limited, so to want limit the quantity of the lucky draw number, for example in the FIG. 5, the lucky draw card 300 can record up to 12 draw numbers at most, the capacity is 1200 points, the transform value is 100, convert the points into the draw number is exactly 12; “Card number” for distinguish other the lucky draw card 300, the card number no repetition and no conflict; “Lucky draw date” say the time of the lucky draw; “Validity period of the bonus exchange” say the validity period of the bonus exchange that after winning in the lucky draw.

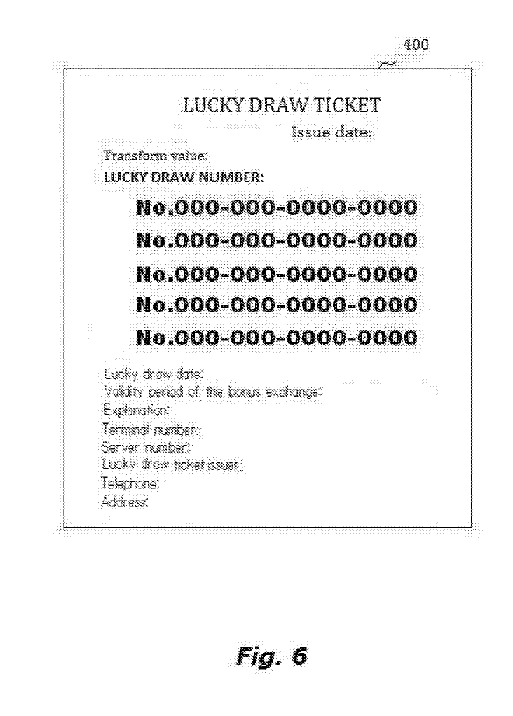

FIG. 6 is a schematic view of the lucky draw ticket 400 provided by the embodiment of the invention. FIG. 6 shows on the surface of the lucky draw ticket 400 there is: “LUCKY DRAW TICKET”, “LUCKY DRAW NUMBER”, “Issue date”, “Lucky draw date”, “Validity period of the bonus exchange”, “Terminal number”, Server number”, and other information. The lucky draw ticket 400 is printed and issue through the terminal 200, using for participate the lucky draw and for the bonus exchange after winning. The lucky draw ticket 400 is not involved the personal information; and the quantity of the lucky draw number not restricted.

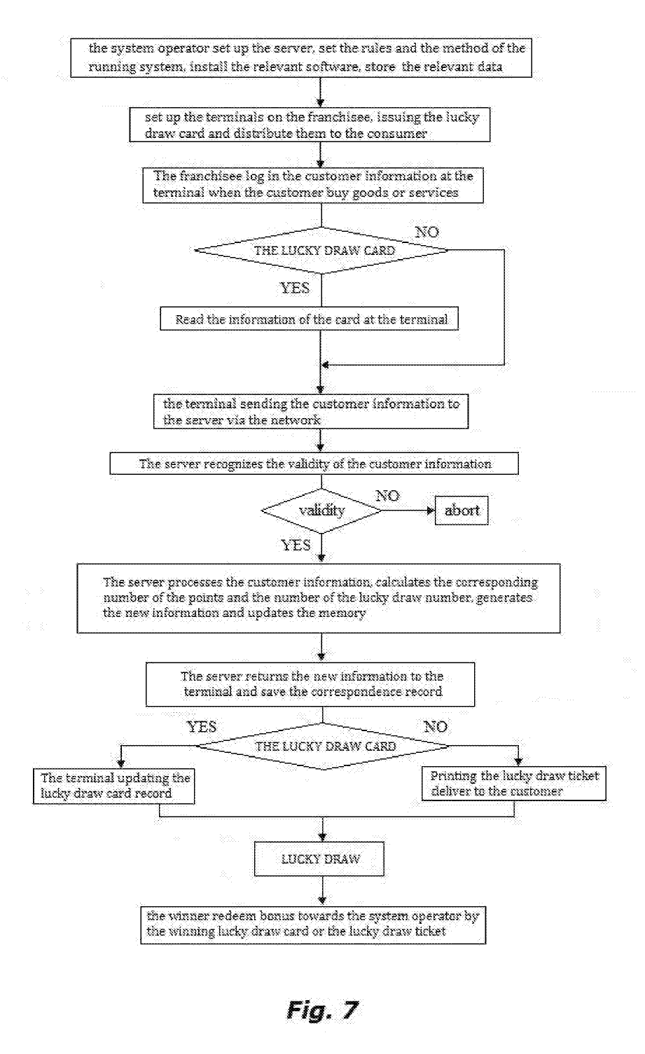

FIG. 7 is a flow chart of the lucky draw system 10 implementation method provided by an embodiment of the present invention. The implementation method comprises the following steps: the system operator 1 set up the server 100, set the rules and method of the running lucky draw system 10, install the relevant software, store the relevant data; the system operator 1 set up the terminal 200 on the franchisee 2, issuing the lucky draw card 300 and distribute them to the consumer; the franchisee 2 log in the customer information 4 at the terminal when the customer 3 buy goods or services, if the customer 3 prompts the lucky draw card 300, read the information in the card 300 as part of the customer information 4; the terminal 200 sending the customer information 4 to the server 100 through the network 500; the server 100 recognizes the validity of the customer information 4: if invalid, abort; if valid, move to the next step; the server 100 processes the customer information 4, calculates the corresponding number of the points and the number of the lucky draw number, generates the new information and update the memory; the server 100 returns the generated new information to the terminal 200 and saves the correspondence record; according to the new information of the returned, the terminal 200 updating the lucky draw card 300 record (the case that the customer 3 prompts the lucky draw card 300), or printing the lucky draw ticket 400 (the case that the customer 3 not prompts the lucky draw card 300); the customer 3 using the lucky draw card 300 or the lucky draw ticket 400 to participate in the lucky draw, the card has the lucky draw number; and the customer 3 using the lucky draw card 300 or the lucky draw ticket 400 wherein containing the winning number to redeem bonus, the bonus pay by the system operator 1.

The businesses need to get the customer 3, the consumer need to get the lucky draw opportunities, the system operator 1 need to get the paid, in the lucky draw system 10 provided in the invention, the system operator 1 provide the terminal 200 to the franchisee 2; the franchisee 2 provide the lucky draw number to their the customer 3 through the terminal 200; the system operator 1 provide the lucky draw and bonus to the winning consumer, therefrom the businesses become the franchisee 2 can obtain the customer 3; the consumer become the customer 3 can get the lucky draw opportunities; the system operator 1 become a provider of promotional means can get the paid from the franchisee 2 and become a provider of payment the bonus. Everyone all gotten to own needed, and everyone all satisfaction.

Although this paper describes an exemplary embodiment of the present invention, however, under circumstances of without departing from the scope of the spirit of the invention, still can in accordance with the disclosed content of the present invention to directly determine or deduce out other deformations or modifications that conform to the principles of the present invention. Therefore, the scope of the present invention should be understood and be cognizance as covering all these deformation or modify.

What is claimed is:

1. A lucky draw system comprising:
a server;
a terminal connecting to the server via the network; and
a lucky draw card able be read and written by the terminal;
wherein the server comprising:
a communication unit comprising: communicating with the terminal to receiving a customer information; and to sending the information data of updating the record of the lucky draw card or printing the record of a lucky draw ticket;
a verification unit comprising: verifying effectiveness of the customer information based on the information data from stored in the server, to determine the continuation or termination of the ongoing procedure, if the customer information is valid, continue, and if is invalid, abort;
a process unit comprising: processing the customer information through the established procedures; converting the customer information to a points according to an established conversion standards, converting the points to a lucky draw number according to an established conversion standards, wherein the lucky draw number no repetition and no conflict; and generating the new information data for updating the record of the lucky draw card or printing the record of the lucky draw ticket, the generated information data Include the part of the points exceeded the conversion standard;
a memory unit comprising saving the related information of communication between the server and the terminal; and;
a database comprising storing and managing the basic data needed by the server when processing and generating information data;
wherein the terminal comprising:
a customer unit comprising: entering the customer information, the customer information including such as the information that can get the points free of charge by purchases of goods or services or by participate in the questionnaire survey, and including the information of the lucky draw card, but do not including personal information;
a terminal communication unit comprising: connecting with the server via the network for exchanging information with the server to transmitting the customer information and receiving the data for updating the record of the lucky draw card or printing the lucky draw ticket; and
a record unit comprising: updating the record of the lucky draw card or printing the lucky draw ticket, wherein updating the lucky draw card record including updating the information stored in the lucky draw card and updating the record that print on the lucky draw card surface;
wherein the lucky draw card comprising: do not involving personal information; able to store information and be read and written by the terminal; using for automatically accumulate the points and the lucky draw number; using for recording the obtained the points and the obtained lucky draw number, using for participate the lucky draw and for the bonus exchange after winning; on the surface of the lucky draw card there is: the points; the lucky draw number; the lucky draw card name; the card number; the transform value; the capacity; the lucky draw date; the validity period of the bonus exchange; and other information; wherein the printed lucky draw number record can only be increase and cannot be change, and when the amount of the points reaches or exceeds the conversion standard, printing the changed the points and the changed lucky draw number;
wherein the lucky draw ticket comprising: do not involving personal information; printing out via the terminal; on the surface of the lucky draw ticket there is: the lucky draw number; the lucky draw ticket name; the lucky draw date; the validity period of the bonus exchange; the terminal number; the server number; and other information; using for participate the lucky draw and for the bonus exchange after winning;
wherein the points using for exchange the lucky draw number, is given by a franchisee through the terminal when the customer purchases goods or services, any customer who buys goods or services at the franchisee can get the points; the points is issued by the server and is recorded on the belonging to the customer lucky draw card through the terminal, or is printed deliver to the customer; the lucky draw number is issued by the server, is recorded on the belonging to the customer lucky draw card through the terminal, and or is printed on the lucky draw ticket by the terminal deliver to the customer.

2. The server according to claim 1, comprising:
a communication unit comprising:
the communication unit communicating with the terminal to receiving the customer information; and to sending the information data of updating the record of the lucky draw card or printing the record of the lucky draw ticket;
a verification unit comprising: verifying effectiveness of the customer information based on the information data from stored in the server, to determine the continuation or termination of the ongoing procedure, if the customer information is valid, continue, and if is invalid, abort;
a process unit comprising: processing the customer information through the established procedures; converting the customer information to the points according to an established conversion standards, converting the points to the lucky draw number according to an established conversion standards, wherein the lucky draw number no repetition and no conflict; and generating the new information data for updating the record of the lucky draw card or printing the record of the lucky draw ticket, the generated information data Include the part of the points exceeded the conversion standard;
a memory unit comprising saving the related information of communication between the server and the terminal; and;
a database comprising storing and managing the basic data needed by the server when processing and generating information data;

3. The terminal according to claim 1, comprising:
a customer unit comprising: entering the customer information, the customer information including the information of purchases of goods or services, including the information of the lucky draw card, but do not including personal information;
a terminal communication unit comprising: connecting with the server via the network for exchanging information with the server to transmitting the customer information and receiving the data for updating the record of the lucky draw card or printing the lucky draw ticket; and
a record unit comprising: updating the record of the lucky draw card or printing the lucky draw ticket, wherein updating the lucky draw card record including updating the information stored in the lucky draw card and updating the record that print on the lucky draw card surface;

4. The terminal according to claim 3, further comprising;
a consume checkout function like the cash register.

5. The terminal according to claim 3, further comprising;
an automatic vending checkout function like the vending machines.

6. The lucky draw card according to claim 1, comprising:
using for automatically accumulate the points and the lucky draw number;
using for recording the obtained the points and the obtained lucky draw number, wherein the printed lucky draw number record can only be increase and cannot be change, and when the amount of the points reaches or exceeds the conversion standard, printing the changed the points and the changed lucky draw number;
using for participate lucky draw activities provide by the system operators;
using for redeem bonus provide by the system;
do not involving personal information;
able to store information and able be read and be written at the terminal; and
marked the lucky draw date, the term of redeem bonus validity and the lucky draw card number, wherein the lucky draw number no repetition and no conflict;

7. The lucky draw ticket according to claim 1, comprising:
printing and releasing via the terminal;
do not involving personal information;
showing the information of the lucky draw date and the bonus payment period;
using for participating in the lucky draw; and
using for redeem bonus after winning;

8. A method for implementing according to claim 1, comprising the steps of:
the system operator 1 set up the server 100, set the rules and method of the running lucky draw system 10, install the relevant software, store the relevant data;
the system operator set up the terminals on the franchisee, issuing the lucky draw card and distribute them to the consumer;
the franchisee log in the customer information at the terminal when the customer buy goods or services, if the customer prompts the lucky draw card, read the information in the card as part of the customer information;
the terminal sending the customer information to the server via the network;
the server recognizes the validity of the customer information: if invalid, abort; if valid, move to the next step;
the server processes the customer information, calculates the corresponding number of the points and the number of the lucky draw number, generates the new information and updates the memory;
the server returns the new information to the terminal and save the correspondence record;
according to the new information of the returned, the terminal updating the lucky draw card record (the case that the customer prompts the lucky draw card), or printing the lucky draw ticket (the case that the customer not prompts the lucky draw card);
the customer using the lucky draw card or the lucky draw ticket to participate the lucky draw, the card has the lucky draw number; and
the customer using the lucky draw card or the lucky draw ticket wherein containing the winning number to redeem bonus, the bonus pay by the system operator.
